(19) United States
(12) Patent Application Publication
(10) Pub. No.: US 2025/0086630 A1
(43) Pub. Date: Mar. 13, 2025

(54) ELECTRONIC COMMUNICATION OF MULTI-FACTOR AUTHENTICATION SETTINGS

(71) Applicant: MASTERCARD TECHNOLOGIES CANADA ULC, Vancouver (CA)

(72) Inventors: Kyle Williams, Wentzville, MO (US); Jonathan McGrandle, Maple Ridge (CA); Matthew Melnik, Delta (CA)

(21) Appl. No.: 18/826,363

(22) Filed: Sep. 6, 2024

Related U.S. Application Data
(60) Provisional application No. 63/581,136, filed on Sep. 7, 2023.

(51) Int. Cl. G06Q 20/40

(52) U.S. Cl. CPC G06Q 20/4014

(57) ABSTRACT

A system is provided for electronically communicating multi-factor authentication (MFA) data. The system includes a remuneration vehicle device including a first communication interface, a first electronic processor, and a first memory, a third-party device including a second communication interface, a second electronic processor, and a second memory, and a server including a third communication interface, a third electronic processor, and a third memory. The third electronic processor is configured to receive, with the third communication interface, a first data packet indicating MFA preferences from the first communication interface, store the MFA preferences in the third memory, receive, with the third communication interface, a second data packet indicating an interaction request from the second communication interface, and provide, with the third communication interface, a third data packet indicating an interaction response to the second communication interface. The third data packet includes the MFA preferences from the third memory.

### CROSS-REFERENCE TO RELATED APPLICATION

This application claim priority to, and the benefit of, U.S. Provisional Application No. 63/581,136, filed on Sep. 7, 2023, the entire contents of which are incorporated herein by reference.

### FIELD OF THE INVENTION

The present disclosure relates generally to user authentication. More specifically, the present disclosure relates to systems, methods, and non-transitory computer-readable media for electronically communicating of multi-factor authentication (MFA) settings including global authorization.

### BACKGROUND

Multi-factor authentication (MFA) is commonly used to authenticate a user and takes various different forms. MFA requires two of three factors to be satisfied in order to perform a valid authentication. The three factors are an inherence factor, a possession factor, and a knowledge factor. The inherence factor is indicating who a user is, the possession factor is indicating what a user has, and the knowledge factor is indicating what a user knows.

One of the most common forms of MFA is a user entering a password followed by the user entering a one-time-password (OTP). The password and the OTP satisfy the possession factor and the knowledge factor, respectively. However, a challenge exists with MFA because of the friction associated with requiring the user to enter the OTP after the password. Some users either do not enable MFA or intentionally disable MFA because these users do not want to provide an OTP or similar information. Additionally, some users associate different avenues of receiving an OTP with different accounts they are trying to access. For example, a user may enroll their email for receiving an OTP for a first account and their phone number for receiving an OTP for a second account. The different avenues of providing MFA causes friction. MFA greatly increases the security of accounts associated with a user and prevents those accounts from being compromised by a hacker, thus, many account providers across different entities see MFA as necessary to keep users secure. However, a user must individually enable MFA across each account separately.

### SUMMARY

Various embodiments of the present disclosure recognize that challenges exist in MFA and provides solutions for MFA in accounts that are provided with a user's remuneration vehicle information. The embodiments disclosed herein solve this pain point by providing a user a way to set a MFA preference (e.g., an OTP type preference) with a remuneration vehicle issuer that authorizes the user to be enrolled in MFA for accounts that interact with their remuneration vehicle. For example, a user may provide preferences associated with MFA and personal information to a remuneration vehicle issuer such that when they use their remuneration vehicle information in an interaction with an entity, the preferences associated with the user's MFA settings will be communicated to the entity from the remuneration vehicle issuer. The entity may then use the MFA preferences to automatically enroll the user in in MFA according to the user's MFA settings. Communicating the user's MFA settings with a remuneration vehicle reduces friction associated with MFA.

Various embodiments of the present disclosure solve challenges associated with MFA, and in particular, globally authorizing MFA across many different entities. In some embodiments, a remuneration vehicle issuer may collect MFA preferences from a remuneration vehicle owner for use with entities and subsequently provide the MFA preferences to a processing server which sends the MFA preferences to the entity when the entity communicates an interaction with the remuneration vehicle to the processing server. The entity may enroll the remuneration vehicle owner in MFA based on the MFA preferences associated with the remuneration vehicle used for the interaction with the entity.

One embodiment herein is a system for electronically communicating multi-factor authentication (MFA) data. The system includes a remuneration vehicle device including a first communication interface, a first electronic processor, and a first memory, a third-party device including a second communication interface, a second electronic processor, and a second memory, and a server including a third communication interface, a third electronic processor, and a third memory. The third electronic processor is configured to receive, with the third communication interface, a first data packet indicating MFA preferences associated with a remuneration vehicle owner from the first communication interface, store the MFA preferences associated with the remuneration vehicle owner in the third memory, receive, with the third communication interface, a second data packet indicating an interaction request by the remuneration vehicle owner from the second communication interface, and provide, with the third communication interface, a third data packet indicating an interaction response to the second communication interface. The third data packet includes the MFA preferences associated with the remuneration vehicle owner from the third memory.

A further embodiment herein is a method for electronically communicating MFA preferences from a server to a third-party device. The method includes receiving, with a communication interface of the server, a first data packet indicating MFA preferences associated with a remuneration vehicle owner from a communication interface of a remuneration vehicle device, storing, with an electronic processor of the server, the MFA preferences associated with the remuneration vehicle owner in a memory of the server, receiving, with the communication interface of the server, a second data packet indicating an interaction request by the remuneration vehicle owner from a communication interface of the third-party device, and providing, with the communication interface of the server, a third data packet indicating an interaction response to the communication interface of the third-party device. The third data packet includes the MFA preferences associated with the remuneration vehicle owner from the memory of the server.

An even further embodiment here is a non-transitory computer-readable medium comprising instructions for electronically communicating MFA preferences associated with a remuneration vehicle owner to a third-party device that, when executed by an electronic processor, cause the electronic processor to perform a set of operations. The set of operations includes receiving, with a communication interface of a server, a first data packet indicating MFA preferences associated with the remuneration vehicle owner from a communication interface of a remuneration vehicle device, storing the MFA preferences associated with the remuneration vehicle owner in a memory of the server, receiving, with the communication interface of the server, a second data packet indicating an interaction request by the remuneration vehicle owner from a communication interface of the third-party device, and providing, with the communication interface of the server, a third data packet indicating an interaction response to the communication interface of the third-party device. The third data packet includes the MFA preferences associated with the remuneration vehicle owner from the memory of the server.

Other aspects of the invention will become apparent by consideration of the detailed description and accompanying drawings.

### BRIEF DESCRIPTION OF THE DRAWINGS

FIG. 1 is a block diagram illustrating a first example system for automatically communicating cardholder Multi-Factor Authentication (MFA) preferences to a third-party device, in accordance with various aspects of the present disclosure.

FIG. 2 is a block diagram illustrating a second example system for automatically communicating cardholder MFA preferences to a third party device, in accordance with various aspects of the present disclosure.

FIG. 3 is a block diagram of example devices for use in the example system of FIG. 1, in accordance with various aspects of the present disclosure.

FIG. 4 schematically illustrates an example communication or data flow for identifying usage of the first example system of FIG. 1, in accordance with various aspects of the present disclosure.

FIG. 5 is a flow diagram illustrating an example process for saving cardholder MFA preferences in an issuer server, in accordance with various aspects of the present disclosure.

FIG. 6 is a flow diagram illustrating an example process of a transaction, in accordance with various aspects of the present disclosure.

FIG. 7 is a flow diagram illustrating an example process of providing a transaction response from a payment processor server to a third-party device, in accordance with various aspects of the present disclosure.

FIG. 8 is a flow diagram illustrating an example process of enrolling a remuneration vehicle in MFA based on remuneration MFA preferences, in accordance with various aspects of the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

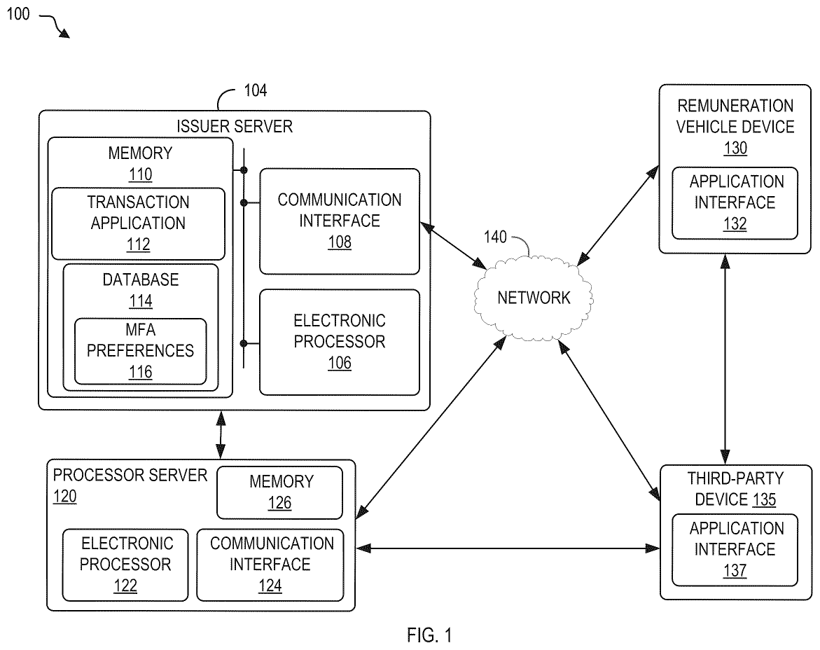

FIG. 1 is a block diagram illustrating a first example system 100 for automatically communicating cardholder Multi-Factor Authentication (MFA) preferences to a third-party device, in accordance with various aspects of the present disclosure. It should be understood that, in some embodiments, there are different configurations from the configuration illustrated in FIG. 1. The functionality described herein may be extended to any number of servers providing distributed processing.

In the example of FIG. 1, the first system 100 includes an issuer server 104, a processor server 120, a remuneration vehicle device 130, a third-party entity device 135, and a network 140. In some examples, the issuer server 104 may be owned by, or operated by or on behalf of, a remuneration vehicle issuer (e.g., the issuer of a credit/debit card).

The issuer server 104 includes an electronic processor 106, a communication interface 108, and a memory 110. The electronic processor 106 is communicatively coupled to the communication interface 108 and the memory 110. The electronic processor 106 is a microprocessor or another suitable processing device. The communication interface 108 may be implemented as one or both of a wired network interface and a wireless network interface. The memory 110 is one or more of volatile memory (e.g., RAM) and non-volatile memory (e.g., ROM, FLASH, magnetic media, optical media, etc.). In some examples, the memory 110 is also a non-transitory computer-readable medium. Although shown within the issuer server 104, memory 110 may be, at least in part, implemented as network storage that is external to the issuer server 104 and accessed via the communication interface 108. For example, all or part of memory 110 may be housed on the “cloud.”

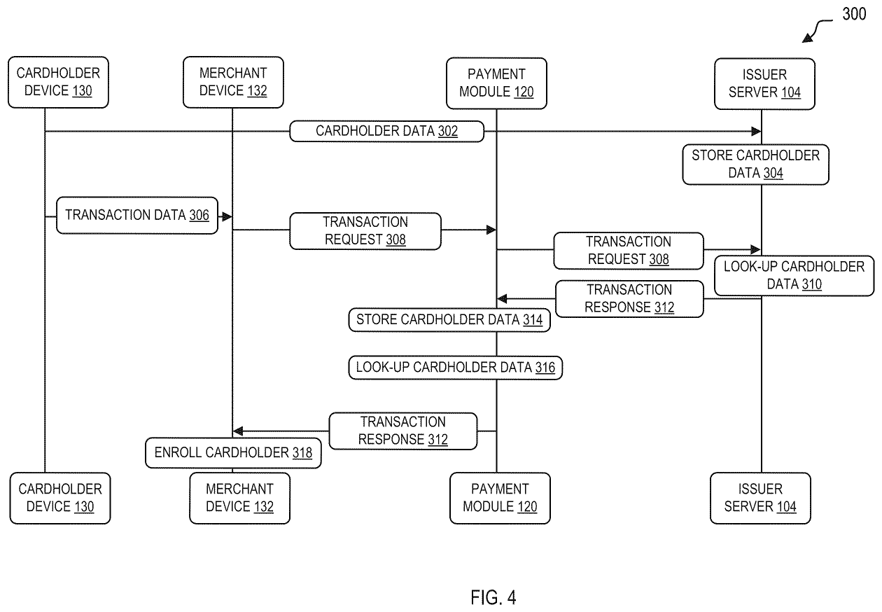

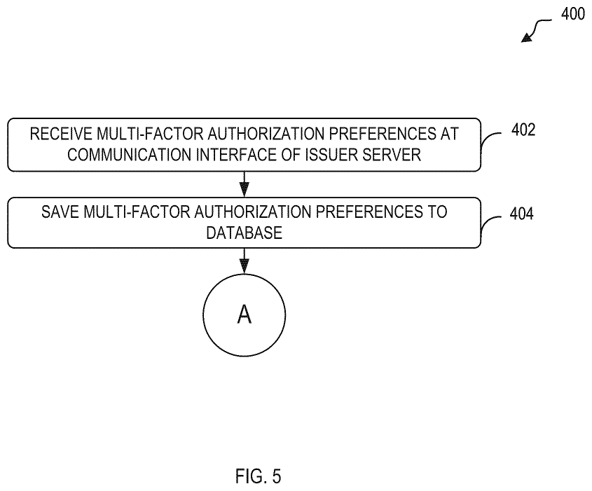

A remuneration application 112 (referred to hereinafter as “transaction application 112”) and a database 114 may be stored in the memory 110. In some embodiments, the transaction application 112 may include machine readable instructions that are executed by the electronic processor 106 to perform the functionality of the issuer server 104 as described below with respect to FIGS. 4 and 5. The database 114 may store MFA preferences 116 received from the remuneration vehicle device 130. For example, MFA preferences 116 may include a one-time-password (OTP) type preference including at least one of an email address, a phone number to call, and a phone number to text. In some embodiments, the database 114 may be a Resource Description Framework (RDF) database or a Structured Query Language (SQL) database (e.g., a knowledge graph). The database 114 may include additional personal information associated with a cardholder. In some embodiments, the database 114 may include a unique cardholder identifier (e.g., a binary value, a universally unique identifier (UUID), etc.) associated with a cardholder that corresponds to a unique card identifier associated with any number of physical, digital, or tokenized payment accounts or cards that are assigned to a cardholder. For example, the remuneration vehicle device 130 may provide MFA preferences 116 associated with a first credit card (e.g., first remuneration vehicle) assigned to a remuneration vehicle owner and the electronic processor 106 may execute the transaction application 112 to associate the MFA preferences 116 with a second credit card also assigned to the remuneration vehicle owner based on the unique card identifier of the second credit card matching (e.g., a determined overlap in identifiers) the unique cardholder identifier associated with the remuneration vehicle owner. In some embodiments, the unique cardholder identifier is assigned to the remuneration vehicle owner (e.g., by the electronic processor 106) when the issuer server 104 first receives any data associated with the remuneration vehicle owner (e.g., first credit card data). In some embodiments, the memory 126 of the processor server 120 may include the database 114 that stores MFA preferences 116. Alternatively, the memory 126 of the processor server 120 and the memory 110 of the issuer server 104 may both include the database 114.

The processor server 120 (referred to hereinafter as “payment server 120) may be a server computer or a web-compatible mobile computer, such as a laptop, a tablet, a smart phone, or other suitable computing device. Alternately, or in addition, the payment server 120 may be a desktop computer. The payment server 120 may be owned by, or operated by or on behalf of, a payment network (e.g., credit card company). The payment server 120 includes an electronic processor 122 in communication with a communication interface 124 and memory 126. The electronic processor 122 is a microprocessor or another suitable processing device, the memory 126 is one or more of volatile memory and non-volatile memory, and the communication interface 124 may be a wireless or wired network interface.

An application, which contains software instructions implemented by the electronic processor 122 of the payment server 120 to perform the functions of the payment server 120 as described herein, is stored within a transitory or a non-transitory portion of the memory 126. In some embodiments, the payment server 120 utilizes the application to create a secure connection between a computing device (e.g., remuneration vehicle device 130 or third-party entity device 135) and a server (e.g., issuer server 104 or payment server 120), or between two networks, using an insecure communication medium such as the public Internet. In some embodiments, communication between the third-party entity device 135 and the issuer server 104 goes through the payment server 120. For example, the third-party entity device 135 may initiate a transaction request (e.g., a transaction data packet) to the issuer server 104 (e.g., after receiving a transaction inquiry from the remuneration vehicle device 130) and the payment server 120 may add additional information to a transaction response (e.g., additional data elements added to the transaction data packet) before the third-party entity device 135 receives the transaction response from the issuer server 104. The additional data elements added to the transaction data packet may include issuer contact information, MFA preferences 116, or any other information stored in the memory 110 of the issuer server 104 or the memory 126 of the payment server 120.

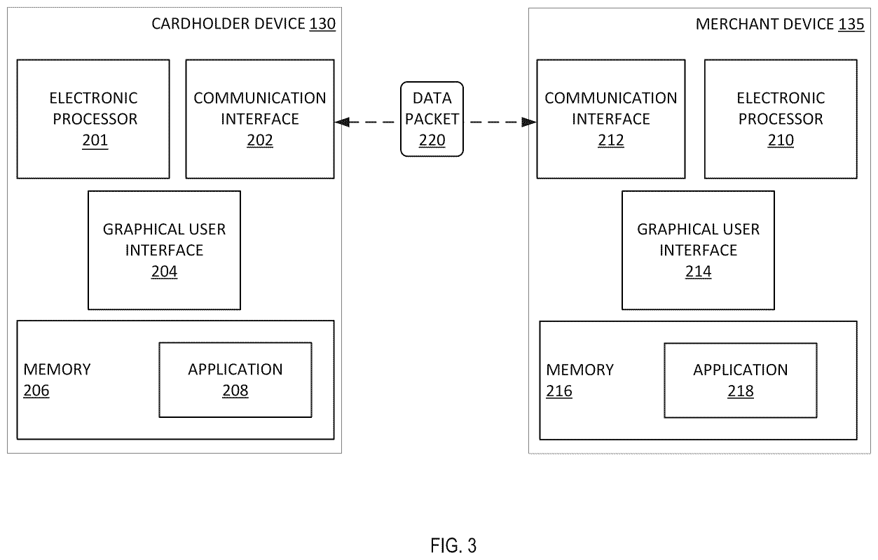

The remuneration vehicle device 130 (referred to hereinafter as “cardholder device 130”) may be a mobile device such as a laptop, a tablet, a smart phone, or other suitable computing device. Alternatively, or in addition, the cardholder device 130 may be a desktop computer. The cardholder device 130 may include an application interface 132. The application interface 132 facilitates interaction with an application, such as application 208 (FIG. 3), which contains software instructions implemented by an electronic processor of the cardholder device 130, such as electronic processor 201 (FIG. 3), to perform the functions of the cardholder device 130 as described herein, is stored within a transitory or a non-transitory portion of a memory, such as memory 206 (FIG. 3). The application may have a graphical user interface (“GUI”), such as GUI 204 (FIG. 3), that facilitates interaction between a remuneration vehicle owner and the cardholder device 130. For example, the application interface 132 is a front-end application of the issuer server 104 or the payment server 120. The cardholder device 130 will be described in detail below with respect to FIG. 3.

The cardholder device 130 may communicate (e.g., send a data packet to) with the issuer server 104, the payment server 120, and the third-party entity device 135 over the network 140. The network 140 is preferably (but not necessarily) a wireless network, such as a wireless personal area network, local area network, or other suitable network. In some examples, the cardholder device 130 may directly communicate with the issuer server 104. In other examples, the cardholder device 130 may indirectly communicate with the issuer server 104 over the network 140. In some embodiment, the network 140 may be encrypted. Alternatively, or additionally, in some embodiments, data communicated between the cardholder device 130 and the issuer server 104, the payment server 120, and the third-party entity device 135 may be encrypted based on instructions from the application.

The third-party entity device 135 (referred to hereinafter as “merchant device 135”) may be a mobile device such as a laptop, a tablet, a smart phone, or other suitable computing device. Alternatively, or in addition, the merchant device 135 may be a desktop computer. The merchant device 135 may include an application interface 137. The application interface 137 facilitates interaction with an application, which contains software instructions implemented by an electronic processor of the merchant device 135, such as electronic processor 210 (FIG. 3), to perform the functions of the merchant device 135 as described herein, that is stored within a transitory or a non-transitory portion of a memory. The application may have a GUI, such as GUI 214 (FIG. 3), that facilitates interaction between a user/merchant and the merchant device 135. For example, the application interface 137 is a front-end application of the issuer server 104 or the payment server 120. The merchant device 135 may communicate with the issuer server 104, the payment server 120, and the cardholder device 130 over the network 140. In some embodiments, data communicated between the merchant device 135 and the issuer server 104, the payment server 120, and the cardholder device 130 may be encrypted based on instructions from the application.

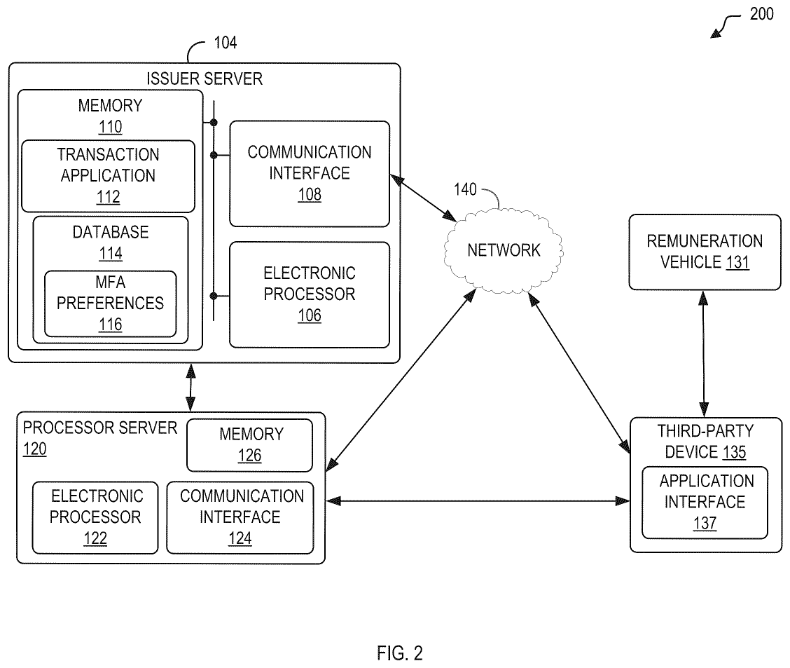

FIG. 2 is a block diagram illustrating a second example system 200 for automatically communicating cardholder Multi-Factor Authentication (MFA) preferences to a third-party device, in accordance with various aspects of the present disclosure. It should be understood that, in some embodiments, there are different configurations from the configuration illustrated in FIG. 2. The functionality described herein may be extended to any number of servers providing distributed processing.

In the example of FIG. 2, the second system 200 includes the issuer server 104, the processor server 120, a remuneration vehicle 131, the third-party entity device 135, and the network 140. In some examples, the issuer server 104 may be owned by, or operated by or on behalf of, a remuneration vehicle issuer (e.g., the issuer of a credit/debit card). The issuer server 104, the processor server 120, the third-party entity device 135, and the network 140 herein are substantially the same as the corresponding elements of the first example system 100 (FIG. 1).

The merchant device 135 may communicate (e.g., send a data packet to) with the issuer server 104 and the payment server 120 over the network 140. In some embodiments, the remuneration vehicle 131 is a credit card that interacts directly with the merchant device 135 when the merchant device 135 is a point-of-sales machine. For example, the remuneration vehicle 131 may be swiped or tapped at the merchant device 135 when making an in-store purchase. In some embodiments, the remuneration vehicle 131 may be a digital credit card provided on a mobile phone.

FIG. 3 is a block diagram of communication between an example cardholder device, such the cardholder device 130, and an example merchant device, such as merchant device 135, in accordance with various aspects of the present disclosure. As mentioned above, the cardholder device 130 may be a mobile device such as a laptop, a tablet, a smart phone, or other suitable computing device. The cardholder device 130 includes an electronic processor 201, a communication interface 202, a GUI 204, and a memory 206. The memory 206 may store an application 208. The electronic processor 201 may execute the instructions of the application 208 based on input to the application interface 132 that is a part of the communication interface 202. In some embodiments, the application 208 includes a database with the renumeration vehicle's MFA preferences 116. For example, the database may store a cardholder's name, MFA enrollment preference, OTP type preference, email address, phone number (e.g., mobile, phone, and work), address, and renumeration vehicle information (e.g., credit card number, expiration date, security code, and cardholder's name) associated with the cardholder. In some embodiments, the application 208 imports the information from another part of the memory 206. In addition to storing the application 208, the memory 206 may be configured to store data and/or instructions that may be executable by the electronic processor 201. For example, the memory 206 may be a random access memory (“RAM”).

The electronic processor 201 may facilitate communication between the communication interface 202 and the GUI 204. In some embodiments, based on input to the GUI 204, the electronic processor 201 may execute the application 208 to send a data packet 220, via the communication interface 202, to at least one of the issuer server 104, the payment server 120, and the merchant device 135. For example, the electronic processor 201 may provide a data packet 220 including at least one of the cardholder's MFA preferences 116 and a unique cardholder identifier to the issuer server 104 or the payment server 120 via the communication interface 202 when a user interacts with the GUI 204 by, for example, inputting their MFA preferences 116 for the first time, updating their MFA preferences 116, or authorizing the MFA preferences 116 to be sent to the issuer server 104 and/or payment server 120. In particular, the electronic processor 201 may provide the data packet to the memory 110 of the issuer server 104 via the communication interface 108 of the issuer server 104. As another example, the electronic processor 201 may provide a data packet 220 including transaction data to the merchant device 135 when a user interacts with the GUI 204 by, for example, purchasing a good off a merchant's website or using a mobile payment device (e.g., mobile credit card) to place an order in a merchant's store. In particular, the electronic processor 201 may provide at least one of the renumeration vehicle information (e.g., credit card number, expiration date, security code, and cardholder's name) and a unique card identifier to the merchant device 135.

In some embodiments, the electronic processor 201 may execute the application 208 that provides the cardholder with an interactive option at the GUI 204 based on data received via the communication interface 202. For example, the issuer server 104 may provide the communication interface 202 with a data packet including an OTP type preference query that solicits a response from the cardholder (e.g., a response that is an input at the GUI 204). The OTP type preference query may be one of a text message, email, or pop-up on the GUI 204 provided by the electronic processor 201 executing the application 208 that solicits a selection by the cardholder as to what OTP type they prefer to be used when their credit card is associated with MFA. In some embodiments, the communication interface 202 is Bluetooth® enabled. Alternatively, or additionally, the communication interface 202 includes cellular communication capabilities and/or WiFi capabilities. In some embodiments, the communication interface 202 includes a physical port that receives an ethernet port.

The merchant device 135 may be similar to the cardholder device 130. For example, the merchant device 135 may include an electronic processor 210, a communication interface 212, a GUI 214, and a memory 216. The GUI 214 may include the application interface 137. The memory 216 may store an application 218 and the electronic processor 210 may execute instructions of the application 218 based on input at the application interface 137. In some embodiments, the memory 206 may be a random access memory (“RAM”).

The electronic processor 210 may facilitate communication between the communication interface 212 and the GUI 214. In some embodiments, based on input to the GUI 214, the electronic processor 210 may execute the application 218 to send a data packet 220, via the communication interface 212 to at least one of the issuer server 104, the payment server 120, and the cardholder device 130. For example, the electronic processor 210 may provide a data packet 220 including a transaction request to the payment server 120 via the communication interface 212 when the communication interface 212 receives transaction data from a cardholder device 130.

FIG. 4 is a flow diagram illustrating an example communication or data flow for identifying usage of the example system of FIG. 1, in accordance with various aspects of the present disclosure. In the example of FIG. 4, a communication environment 300 includes the cardholder device 130, the merchant device 135, the payment server 120, and the issuer server 104. The communication environment 300 includes a set of data packets 220 including transaction information transmitted in the process of a merchant device 135 automatically receiving MFA preferences 116 from the payment server 120 during a transaction.

In one embodiment, the cardholder device 130 provides cardholder data 302 to the issuer server 104. For example, cardholder data 302 may include at least one of the cardholder's MFA preferences 116 (e.g., MFA enrollment preference, OTP type preference, email address, and phone number), cardholder personal information (e.g., the cardholder's name, email address, phone number (e.g., mobile, phone, and work), renumeration vehicle information (e.g., credit card number, expiration date, security code, and cardholder's name), and a unique cardholder identifier. In some embodiments, a cardholder inputs the cardholder data 302 at the GUI 204. In some embodiments, the electronic processor 201 executes the application 208 to create the unique cardholder identifier when the cardholder data 302 is provided to the issuer server 104. The issuer server 104 stores the cardholder data 304 upon receipt of the cardholder data 302. For example, the issuer server 104 may store the cardholder data 304 in the database 114. In some embodiments, cardholder data 302 may be directly input into the issuer server 104. For example, a cardholder may visit a branch associated with the issuer server and a teller may input the cardholder data 302 into the issuer server 104. In some embodiments, the issuer server 104 adds a unique cardholder identifier to the received cardholder data 302 when the cardholder data 302 is stored. Alternatively, or additionally, in some embodiments, the cardholder device 130 provides the cardholder data 302 to the payment server 120 and the payment server 120 stores the cardholder data 304.

The cardholder device 130 may also provide transaction data 306 to the merchant device 135. For example, transaction data 306 may include an item purchased identifier, renumeration vehicle information (e.g., credit card number, expiration date, security code, and cardholder's name), a unique card identifier, cardholder device 130 location, and shipping preferences (e.g., shipping time preference and address). In some embodiments, the transaction data 306 is provided by the cardholder device 130 to the merchant device 135 in response to a user interacting with a transaction platform provided on the GUI 204 of the cardholder device 130. In some embodiments, transaction data 306 is input directly into the merchant device 135. For example, a cardholder may place a purchase in store and merchant may directly input the transaction data 306 into the merchant device 135 via the GUI 214 of the merchant device 135.

The merchant device 135 may provide a transaction request 308 to the payment server 120. In some embodiments, the transaction request 308 may include the transaction data 306 and an authorization request. For example, the authorization request may be request that inquires whether the cardholder has sufficient funds (e.g., bank account available balance or available credit limit) to purchase the item. The payment server 120 may process the transaction request 308 and forward the transaction request 308 to the issuer server 104. The issuer server 104 may look-up cardholder data 310 associated with the transaction request 308. For example, based on the transaction data 306, the issuer server 104 may access cardholder data 302 stored in the database 114. The issuer server 104 may match one of the unique card identifier, credit card number, expiration date, security code, and cardholder's name (e.g., the transaction data 306) to at least some of the cardholder data 302. For example, the electronic processor 106 of the issuer server 104 may match the received unique card identifier with the stored unique cardholder identifier to extract MFA preferences 116.

In some embodiments, when the payment server 120 stores the cardholder data 304, the transaction request 308 may not be provided to the issuer server 104 by the payment server 120. Rather, the payment server 120 may look-up the cardholder data 310 in the memory 126 of the payment server 120.

The issuer server 104 may provide a transaction response 312 to the payment server 120. For example, the transaction response 312 may include at least one of the cardholder's personal information, the cardholder's MFA preferences 116, an authorization request response, and a notice that the cardholder has sufficient funds for the item. In some embodiments, the transaction response 312 is encrypted. In some embodiments, the authorization request response may be a sub-element under the cardholder's personal data in the transaction response 312 that ensures predetermined security and encryption are applied the cardholder's personal information. For example, the authorization request response may not be encrypted and the cardholder's personal information may be encrypted so the personal information is not unnecessarily viewed (e.g., by the merchant).

When MFA preferences 116 are provided by the issuer server 104 to the payment server 120, the payment server 120 stores the MFA preferences 314. For example, the payment server 120 may store the cardholder's MFA preferences 116 in the memory 126 of the payment server 120. When MFA preferences 116 are not provided by the issuer server 104 to the payment server 120 (e.g., in scenarios where the cardholder device 130 does not provide MFA preferences with the transaction request 308), the payment server 120 looks-up the cardholder data 316. For example, the payment server 120 may include MFA preferences 116 stored in a dedicated database (e.g., similar to database 114) and the payment server 120 may look up the MFA preferences 116 when a transaction request 308 is received. In some embodiments, the electronic processor 122 of the payment server 120 may match the unique card identifier received with the transaction request 308 with the unique cardholder identifier associated with cardholder data 302 to extract MFA preferences 116. When the payment server 120 receives the MFA preferences 116 and the MFA preferences include a global enrollment preference (e.g., as communicated by the cardholder device 130 to the issuer server 104), the payment server 120 provides global authorization to use the renumeration vehicle as MFA when the cardholder device 130 (e.g., the renumeration vehicle owner) provides the renumeration vehicle (e.g., in a transaction) to a merchant device 135.

The payment server 120 may provide the transaction response 312 to the merchant device 135. In some embodiments, the payment server adds additional data to the transaction response 312 before sending the transaction response 312 to the merchant device 135. For example, the payment server 120 may automatically add the issuer's contact information (e.g., phone number, email, or mailing address) and MFA preferences 116 to the transaction response 312 when the transaction response 312 from the issuer server 104 does not provide the MFA preferences 116.

The merchant device 135 may enroll the cardholder in MFA 318 based on the received MFA preferences 116. For example, the electronic processor 210 of the merchant device 135 may execute the application 218 to enroll the cardholder in MFA according to their MFA preferences 116. In some embodiments, the MFA preferences 116 may include data corresponding to a confirmation of MFA enrollment and an OTP type preference (e.g., email address or phone number).

FIG. 5 is a flow diagram illustrating an example process 400 for saving MFA preferences information to an issuer server, such as issuer server 104, in accordance with various aspects of the present disclosure. In the example of FIG. 4, the process 400 is described in a sequential flow, however, some of the process 400 may also be performed in parallel. It is understood that the process 400 may be stored in a memory, such as memory 110 of the issuer server 104, and executed by a processor, such as electronic processor 106. Accordingly, while the process 400 is described in regards to the issuer server 104, it is contemplated that the process 400 may be at least partially performed alternatively or additionally by the payment server 120.

The communication interface 108 receives MFA preferences 116 from a cardholder device (block 402). For example, the communication interface 108 of the issuer server 104 receives a first data packet including and indicating cardholder data 302 from the cardholder device 130, via the communication interface 202 of the cardholder device 130. In some embodiments, a cardholder inputs their MFA preferences (e.g., a cardholder's preference to be globally enrolled in MFA associated with their credit card, OTP type preference, phone number, and email address) at the GUI 204 of the cardholder device 130 when the electronic processor 201 executes the application 208 and the electronic processor 201 further executes the application 208 to collect the MFA preferences and creates the first data packet (e.g., cardholder data 302) for transmission by the communication interface 202 that includes the MFA preferences 116. The electronic processor 106 saves the MFA preferences 116 in a database (block 404). For example, the electronic processor 106 saves the MFA preferences 116 in the database 114 of the memory 110 of the issuer server 104. In some embodiments, the electronic processor 106 adds a unique cardholder identifier to the MFA preferences 116 in the first data packet including the cardholder data 302. The process 400 continues to example process 500.

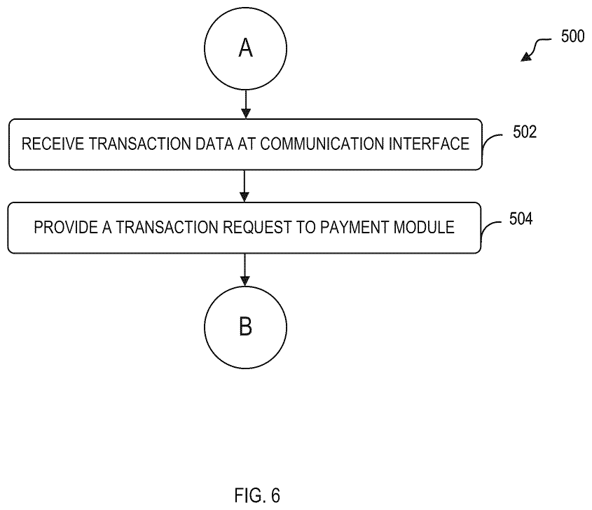

FIG. 6 is a flow diagram illustrating example process 500 of a transaction, in accordance with various aspects of the present disclosure. In the example of FIG. 5, the process 500 is described in a sequential flow, however, some of the process 500 may also be performed in parallel. It is understood that the process 500 may be stored in a memory, such as memory 216 of the merchant device 135, and executed by a processor, such as electronic processor 210 of the merchant device 135. Accordingly, the process 500 is described in regards to merchant device 135. In some embodiments, the process 500 may be executed in conjunction with or in response to the steps of process 400.

The communication interface 202 of the merchant device 135 receives transaction data (block 502). For example, the communication interface 202 receives a second data packet including and indicating the transaction data 306 from the cardholder device 130, via the communication interface 202 of the cardholder device 130. In some embodiments, a remuneration vehicle owner inputs renumeration vehicle information (e.g., credit card number, expiration date, security code, and cardholder's name), into a transaction platform displayed on the GUI 214 of the cardholder device 130 by the electronic processor 210 executing the application 218 and the electronic processor 210 collects the credit card information by further executing the application 218 and creates the second data packet (e.g., the transaction data 306) for transmission by the communication interface 202 that includes the credit card information. The communication interface 202 of the merchant device 135 provides a transaction request to a payment server (block 504). For example, the transaction request 308 is provided by the communication interface 202 of the merchant device 135 to a communication interface 124 of the payment server 120 and includes the transaction data 306 and an authorization request. In some embodiments, the electronic processor 210 of the merchant device 135 executes the application 218 to attach additional data (e.g., unique card identifier) to the second data packet (e.g., transaction data 306) to create a third data packet (e.g., transaction request 308). In some embodiments, block 502 is not required. For example, a remuneration vehicle owner may directly provide a credit card to the merchant device 135 when the merchant device 135 is a point-of-sale machine. The process 500 continues to example process 600.

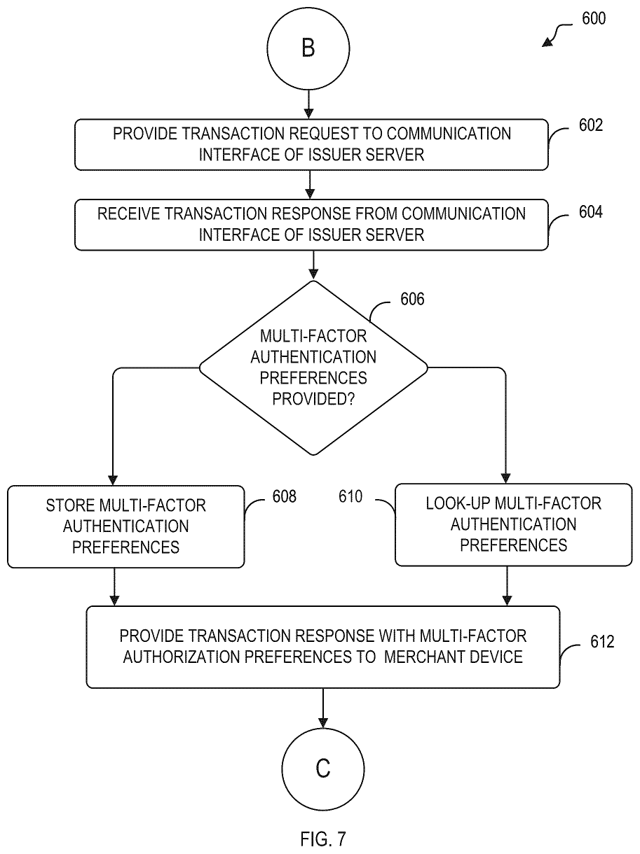

FIG. 7 is a flow diagram illustrating the example process 600 of providing a transaction response with MFA to a merchant device, such merchant device 135, in accordance with various aspects of the present disclosure. In the example of FIG. 6, the process 600 is described in a sequential flow, however, some of the process 600 may also be performed in parallel. It is understood that the process 600 may be stored in a memory, such as memory 126 of the payment server 120, and executed by a processor, such as electronic processor 122 of the payment server 120. Accordingly, the process 600 is described in regards to payment server 120. In some embodiments, the process 600 may be executed in conjunction with or in response to the steps of process 400 and/or process 500.

The communication interface 124 of the payment server 120 provides a transaction request to the issuer server 104 (block 602). For example, the communication interface 124 sends a fourth data packet including and indicating the transaction request 308 to the communication interface 108 of the issuer server 104. In some embodiments, the payment server 120 automatically provides the fourth data packet (e.g., the transaction request 308) to the issuer server 104 upon receipt of the third data packet from the merchant device 135. In some embodiments, the third data packet and the fourth data packet are the same. Alternatively, in some embodiments, the fourth data packet includes additional data from the third data packet. For example, the electronic processor 122 of the payment server 120 may add a unique card identifier associated with the credit card number of the third data packet to create the fourth data packet. In some embodiments, payment server 120 includes cardholder data 302 in the memory 126 of the payment server 120 and does not provide the transaction request to the issuer server 104.

The communication interface 124 of the payment server 120 receives a transaction response from the issuer server 104 (block 604). For example, the communication interface 124 may receive a fifth data packet including and indicating a transaction response 312 from the communication interface 108 of the issuer server 104. In some embodiments, the fifth data packet (e.g., the transaction response 312) includes at least one of the cardholder's personal information, an authorization request response, and MFA preferences 116. In some embodiments, the electronic processor 106 of the issuer server 104 matches the unique card identifier to a unique cardholder identifier associated with the cardholder data 302 to locate the MFA preferences 116. For example, the issuer server 104 may match at least a portion of the unique card identifier to the unique cardholder identifier stored in the database 114. In some embodiments, the fifth data packet is encrypted. In some embodiments, the fifth data packet includes the data from the fourth data packet (e.g., the transaction request 308).

The electronic processor 122 of the payment server 120 parses the fifth data packet to determine whether MFA preferences are provided by the issuer server 104 (decision block 606). For example, the electronic processor 122 of the payment server 120 may attempt to identify a sub-element within the fifth data packet that is associated with the MFA preferences 116. In some embodiments, the MFA preferences 116 include a global enrollment preference that globally links MFA to a cardholder's credit card during any transaction between the cardholder device 130 and a merchant device 135. Additionally, in some embodiments, the MFA preferences 116 include an OTP type preference (e.g., email authentication, text message authentication, or phone call authentication).

When MFA preferences 116 are provided by the issuer server 104, the process 600 continues to block 608. The electronic processor 122 of the payment server 120 saves the MFA preferences 116 (block 608). In some embodiments, the electronic processor 122 of the payment server 120 saves the MFA preferences 116 to the memory 126 of the payment server 120. The process 600 continues to block 612.

When MFA preferences 116 are not provided by the issuer server 104, the process 600 continues to block 610. The electronic processor 122 of the payment server 120 looks-up MFA preferences 116 in the memory 126 of the payment server 120 (block 610). In some embodiments, the electronic processor 122 determines that the cardholder has previously provided MFA preferences for the credit card used. For example, a unique cardholder identifier may be stored in the memory 126 of the payment server 120 and the electronic processor 122 may match the received unique card identifier to the unique cardholder identifier to determine MFA preferences 116 associated with one of the credit card and the cardholder. As another example, a first unique card identifier associated with a different credit card assigned to the cardholder may be stored in the memory 126 and the electronic processor 122 may match (e.g., contain overlapping data) a second unique card identifier associated with the credit card used in the transaction request 308 to the first unique card identifier to determine MFA preferences that are associated with the different credit card assigned to the cardholder, but not used in the transaction between the cardholder device 130 and the merchant device 135. In some embodiments, the electronic processor 122 of the payment server 120 looks-up the MFA preferences 116 in the memory 126 with each transaction, regardless of a determination whether the MFA preferences 116 are provided by the issuer server 104.

The communication interface 124 of the payment server 120 provides a transaction response including MFA preferences 116 to the merchant device 135 (block 612). For example, the communication interface 124 sends the fifth data packet including the transaction response 312 to the communication interface 212 of the merchant device 135 when the fifth data packet includes the MFA preferences 116 from the issuer server 104. In some embodiments, the payment server 120 adds additional data to the fifth data packet before sending the fifth data packet to the merchant device 135. As another example, the electronic processor 122 of the payment server 120 may add the MFA preferences 116 from the memory 126 (i.e., as discussed above with respect to block 610) to the fifth data packet to create a sixth data packet that is sent to the merchant device 135. After the MFA preferences 116 are communicated to the merchant device 135, the process 600 continues to example process 700.

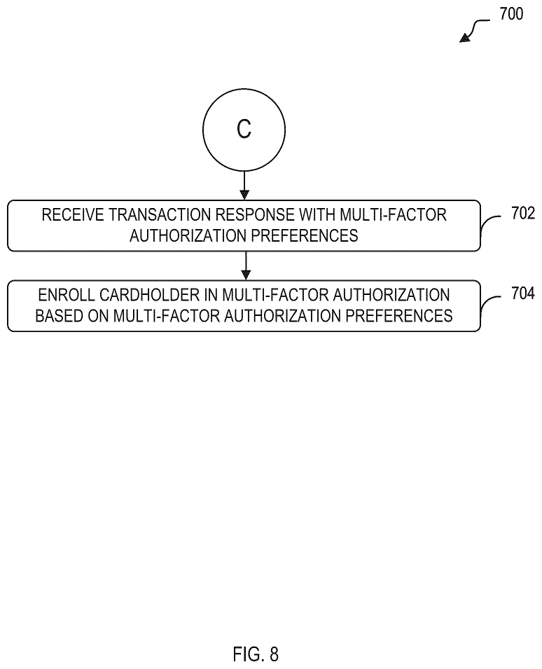

FIG. 8 is a flow diagram illustrating an example process 700 of enrolling a cardholder in MFA, in accordance with various aspects of the present disclosure. In the example of FIG. 7, the process 700 is described in a sequential flow, however, some of the process 700 may also be performed in parallel. It is understood that the process 700 may be stored in a memory, such as memory 216 of the merchant device 135, and executed by a processor, such as electronic processor 210 of the merchant device 135. Accordingly, the process 700 is described in regards to merchant device 135. In some embodiments, the process 700 may be executed in conjunction with or in response to the steps of process 600.

The communication interface 212 of the merchant device 135 receives the transaction response with MFA preferences 116 from the payment server 120 (block 702). For example, the communication interface 212 receives the fifth data packet or the sixth data packet including the transaction response 312 from the communication interface 124 of the payment server 120. The fifth data packet or the sixth data packet includes MFA preferences 116. In some embodiments, the electronic processor 210 of the merchant device 135 executes the application 218 to parse the fifth data packet or the sixth data packet to determine a particular element of the MFA preferences 116. For example, the electronic processor 210 may extract at least one of an MFA enrollment preference, an OTP type preference, a phone number and an email address from the fifth data packet or the sixth data packet.

The electronic processor 210 of the merchant device 135 enrolls the cardholder in MFA based on the MFA preferences 116 (block 704). For example, the electronic processor 210 may execute the application 218 to enroll the cardholder in MFA according to the MFA preferences 116 when the electronic processor 201 of the cardholder device 130 executes the application 208 upon launching the application 208 (e.g., when a user selects a tile corresponding to the application 208 on the GUI 204). In some embodiments, the electronic processor 210 of the merchant device 135 executes the application 218 to enroll the cardholder in MFA including an OTP that is a text message to the cardholder's phone number. Alternatively, in some embodiments, the electronic processor 210 of the merchant device 135 executes the application 218 to enroll the cardholder in MFA including an OTP that is an email to the cardholder's email address.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It should thus be noted that the matter contained in the above description or shown in the accompanying drawings is to be interpreted as illustrative and not in a limiting sense.

What is claimed is:

1. A system for electronically communicating multi-factor authentication (MFA) data, the system comprising:
a remuneration vehicle device including a first communication interface, a first electronic processor, and a first memory;
a third-party device including a second communication interface, a second electronic processor, and a second memory; and
a server including a third communication interface, a third electronic processor, and a third memory, the third electronic processor configured to:
receive, with the third communication interface, a first data packet indicating MFA preferences associated with a remuneration vehicle owner from the first communication interface,
store the MFA preferences associated with the remuneration vehicle owner in the third memory,
receive, with the third communication interface, a second data packet indicating an interaction request by the remuneration vehicle owner from the second communication interface, and
provide, with the third communication interface, a third data packet indicating an interaction response to the second communication interface,
wherein the third data packet includes the MFA preferences associated with the remuneration vehicle owner from the third memory.

2. The system of claim 1, wherein the first data packet includes at least one of an automatic MFA enrollment preference, a one-time-password (OTP) type preferences, a phone number, and an email address.

3. The system of claim 1, wherein the server is one of a payment processor server and an issuer server.

4. The system of claim 1, wherein the remuneration vehicle device, the third-party device, and the server communicate over a network.

5. The system of claim 1, wherein the second electronic processor is configured to:
receive, with the second communication interface, the third data packet, and
automatically enroll the remuneration vehicle owner associated with the remuneration vehicle device in MFA based on the MFA preferences associated with the remuneration vehicle owner of the third data packet.

6. The system of claim 5 wherein the third electronic processor is further configured to:
receive, with the third communication interface, a fourth data packet indicating a second interaction request from a fourth communication interface of a second third-party device that is different from the third-party device, and
provide, with the third communication interface, a fifth data packet indicating a second interaction response to the fourth communication interface,
wherein the fifth data packet includes the MFA preferences associated with the remuneration vehicle owner from the third memory.

7. The system of claim 6, wherein a fourth electronic processor of the second third-party device is configured to:
receive, with the fourth communication interface, the fifth data packet, and
enroll the remuneration vehicle owner associated with the remuneration vehicle device in MFA based on the MFA preferences associated with the remuneration vehicle owner of the fifth data packet.

8. The system of claim 1, wherein the interaction request is a credit card transaction request including first credit card data.

9. The system of claim 8, wherein the third electronic processor is further configured to:
receive, with the third communication interface, a fourth data packet indicating a second interaction request, wherein the second interaction request is a second credit card transaction request including second credit card data, and
determine MFA preferences associated with the remuneration vehicle owner based on the second credit card data.

10. The system of claim 9, wherein the first credit card data includes a first unique card identifier that matches a unique cardholder identifier associated with the remuneration vehicle owner and the second credit card data includes a second unique card identifier that matches the unique cardholder identifier.

11. A method for electronically communicating MFA preferences from a server to a third-party device, the method comprising:
receiving, with a communication interface of the server, a first data packet indicating MFA preferences associated with a remuneration vehicle owner from a communication interface of a remuneration vehicle device,
storing, with an electronic processor of the server, the MFA preferences associated with the remuneration vehicle owner in a memory of the server,
receiving, with the communication interface of the server, a second data packet indicating an interaction request by the remuneration vehicle owner from a communication interface of the third-party device, and
providing, with the communication interface of the server, a third data packet indicating an interaction response to the communication interface of the third-party device,
wherein the third data packet includes the MFA preferences associated with the remuneration vehicle owner from the memory of the server.

12. The method of claim 11, wherein the server is one of a payment processor server and an issuer server.

13. The method of claim 11 further comprising:
receiving, with the communication interface of the third-party device, the third data packet, and
enrolling, with an electronic processor of the third-party device, a cardholder associated with the remuneration vehicle device in MFA based on the MFA preferences associated with the remuneration vehicle owner of the third data packet.

14. The method of claim 11, wherein the interaction request is a credit card transaction request including first credit card data.

15. The method of claim 14 further comprising:
receiving, with the communication interface of the server, a fourth data packet indicating a second interaction request, wherein the second interaction request is a second credit card transaction request including second credit card data, and
determining MFA preferences associated with the remuneration vehicle owner based on the second credit card data.

16. The method of claim 15, wherein the first credit card data includes a first unique card identifier that matches a unique cardholder identifier associated with the remuneration vehicle owner and the second credit card data includes a second unique card identifier that matches the unique cardholder identifier.

17. A non-transitory computer-readable medium comprising instructions for electronically communicating MFA preferences associated with a remuneration vehicle owner to a third-party device that, when executed by an electronic processor, cause the electronic processor to perform a set of operations comprising:
receiving, with a communication interface of a server, a first data packet indicating MFA preferences associated with the remuneration vehicle owner from a communication interface of a remuneration vehicle device,
storing the MFA preferences associated with the remuneration vehicle owner in a memory of the server,
receiving, with the communication interface of the server, a second data packet indicating an interaction request by the remuneration vehicle owner from a communication interface of the third-party device, and
providing, with the communication interface of the server, a third data packet indicating an interaction response to the communication interface of the third-party device,
wherein the third data packet includes the MFA preferences associated with the remuneration vehicle owner from the memory of the server.

18. The non-transitory computer-readable medium of claim 17, wherein the first data packet includes at least one of a MFA enrollment preference, a one-time-password (OTP) type preferences, a phone number, and an email address.

19. The non-transitory computer-readable medium of claim 17, wherein the server is one of a payment processor server and an issuer server.

20. The non-transitory computer-readable medium of claim 17, wherein the third data packet includes a transaction that is encrypted by the electronic processor.
